(19) United States
(12) Patent Application Publication
(10) Pub. No.: US 2016/0010369 A1
(43) Pub. Date: Jan. 14, 2016

(54) DOOR HANDLE ARRANGEMENT FOR A MOTOR VEHICLE DOOR

(71) Applicants: Martin SPECHT, Feldafing (DE); Ullrich JULING, Prien (DE)

(72) Inventors: Martin SPECHT, Feldafing (DE); Ullrich JULING, Prien (DE)

(21) Appl. No.: 14/751,920

(22) Filed: Jun. 26, 2015

(30) Foreign Application Priority Data
Jul. 8, 2014 (DE) 10 2014 213 184.7

(51) Int. Cl. E05B 85/16

(52) U.S. Cl. CPC E05B 85/16

(57) ABSTRACT

A door handle arrangement for a motor vehicle with a door recess in which a movably mounted handle element for actuating a door lock is arranged recessed relative to a door outer skin, and with a cover for covering the door recess, the cover being arranged movably between an inoperative position running flush with the door outer skin and an actuating position. The handle element has a movable recessed grip which remains behind the door outer skin, —as viewed from the outside, —both in an inoperative position and in an actuating position.

### CROSS-REFERENCE TO RELATED APPLICATIONS

This application claims priority from German Patent Application DE 10 2014 213 184.7, filed on Jul. 8, 2014, the disclosure of which is hereby incorporated by reference into this application.

### FIELD OF THE INVENTION

The invention relates to a door handle arrangement for a motor vehicle door, with a door recess in which a movably mounted handle element for actuating a door lock is arranged recessed relative to a door outer skin, and with a cover for covering the door recess, the cover being arranged movably between an inoperative position running flush with the outer skin and an actuating position.

### BACKGROUND OF THE INVENTION

A door handle arrangement of this type is known from DE 198 47 212 A1. The known door handle arrangement has a recessed grip which is fixed to the door outer skin and is arranged behind a door recess of the door outer skin. A handle element which is arranged below the door recess and is pivotable in the recessed grip behind the door outer skin is mounted pivotably in the recessed grip. The door recess is closable by a pivotable cover which, in the actuating position thereof, opens up the door recess and therefore access to the recessed grip.

### SUMMARY OF THE INVENTION

It is the object of the invention to provide a door handle arrangement of the type mentioned above, which has a simple construction and is readily operable.

This object is achieved in that the handle element has a movable recessed grip which remains behind the door outer skin—as viewed from the outside—both in an inoperative position and in an actuating position. By means of the movable recessed grip, it is possible to design a door space behind the door recess in the door outer skin to be open. A closed, stationary recessed grip design, as is the case in the prior art, is not necessary. The movable recessed grip permits simple and ergonomically favourable operability by means of an operator.

In a refinement of the invention, the handle element comprises a cover section which is shiftable with the recessed grip and, in the inoperative position, covers a part of the door recess below the cover in a manner flush with the outer skin, and which, in the actuating position, protrudes outwards over the door outer skin. The cover section is preferably formed integrally with the recessed grip. Whether formed integrally or in a number of parts, the cover section is fixedly connected to the recessed grip in order to be able to be shifted together therewith. The recessed grip can be shiftable relative to the door outer skin pivotably, in a linearly movable manner or in a manner movable along a curved track. In the inoperative position, an outer side of the cover section and the cover arranged thereabove close the door recess in a manner flush with the outer skin, and therefore the door outer skin is designed to be favourable in terms of flow even in the region of the door recess and visually as a continuous surface.

In a further refinement of the invention, the recessed grip is designed to be open at least in sections on the base side. The recessed grip extends downwards from the cover section of the handle element, and therefore an operator can engage in the recessed grip from above. The design of a base of the recessed grip so as to be open at least in sections enables water to flow downwards out of the recessed grip.

In a further refinement of the invention, a water-catching shell is provided in a manner mounted on the door below the recessed grip, the water-catching shell having a water outlet, which, in an operating state, is connected to a water outlet system. The water-catching shell catches water which penetrates into the door interior through the door recess and possibly through the recessed grip. The water is removed to the lower side of the vehicle via the water outlet and the water outlet system. Moisture accumulations in the region of the door recess can thereby be avoided.

In a further refinement of the invention, the handle element is mounted with the recessed grip and the cover section on a front or rear edge region of the door recess so as to be pivotable about a pivot axis extending at least substantially in the vertical direction of the vehicle. The pivot axis is advantageously arranged on the front edge region of the door recess—as seen in the normal direction of travel —in order to permit an ergonomically favourable pivoting movement of the recessed grip for opening of the motor vehicle door.

In a further refinement of the invention, the cover is mounted on an upper edge region of the door recess so as to be pivotable about a pivot axis extending at least substantially in the longitudinal direction of the vehicle. The wording “at least substantially” means that a predominant extension component of the respective pivot axis is provided in the vertical direction of the vehicle or in the longitudinal direction of the vehicle. The cover, in the inoperative position thereof, is positioned flush with the door outer skin and flush with the edge of the door recess. Downwards, the cover is oriented flush and in alignment with the outer side of the cover section of the handle element as long as the handle element is also in the inoperative position thereof. In the actuating position, the cover is pivoted inwards into the door recess in order to open up the access for an operator to the movable recessed grip.

In a further refinement of the invention, the cover is assigned a drive unit for transferring the cover into the actuating position and/or into the inoperative position. If the drive unit is provided merely for transferring the cover into the inoperative position, the drive unit can be formed by a mechanical spring accumulator which is arranged, preferably in the form of a leg spring, in the region of the pivot mounting of the cover. If the cover is intended to be transferred into the actuating position by the drive unit, an electric motor, a hydraulic motor or a pneumatic servomotor is preferably provided.

In a further refinement of the invention, the drive unit comprises an electric motor which is coupled to a door lock controller in such a manner that the cover is transferred into the actuating position when the door lock is unlocked. The actuation of the cover can preferably take place wirelessly by the drive unit via a remote control of the door lock controller.

In a further refinement of the invention, in the actuating position, the cover is pivoted inwards into the door recess. The cover is preferably blocked in said actuating position in order to avoid injuries to an operator engaging in the recessed grip when the cover is open.

### BRIEF DESCRIPTION OF THE DRAWINGS

Further advantages and features of the invention emerge from the claims and from the description below of a preferred exemplary embodiment of the invention, which is illustrated with reference to the drawings.

FIG. 1 shows an embodiment of a door handle arrangement according to the invention in a perspective illustration from an outer side,

FIG. 2 shows the door handle arrangement according to FIG. 1 in a different perspective illustration from an inner side,

FIG. 3 shows the door handle arrangement according to FIG. 1 in an actuating position of a cover,

FIG. 4 shows the illustration of the door handle arrangement according to FIG. 3 in a perspective illustration from the inside,

FIG. 5 shows the door handle arrangement according to FIGS. 1 to 4 in an actuating position both of the cover and of a movable recessed grip, and

FIG. 6 shows the position of the door handle arrangement according to FIG. 5 in a perspective illustration from an inner side.

### DETAILED DESCRIPTION

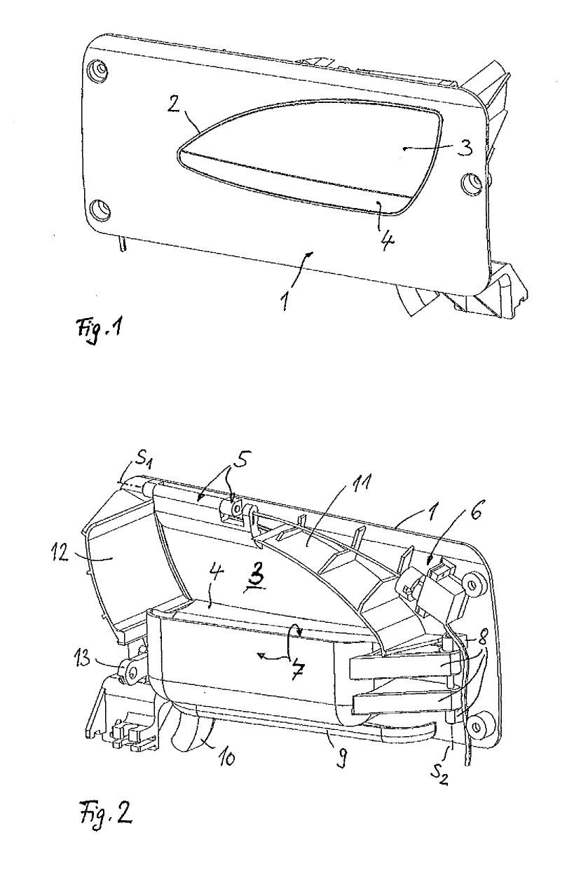

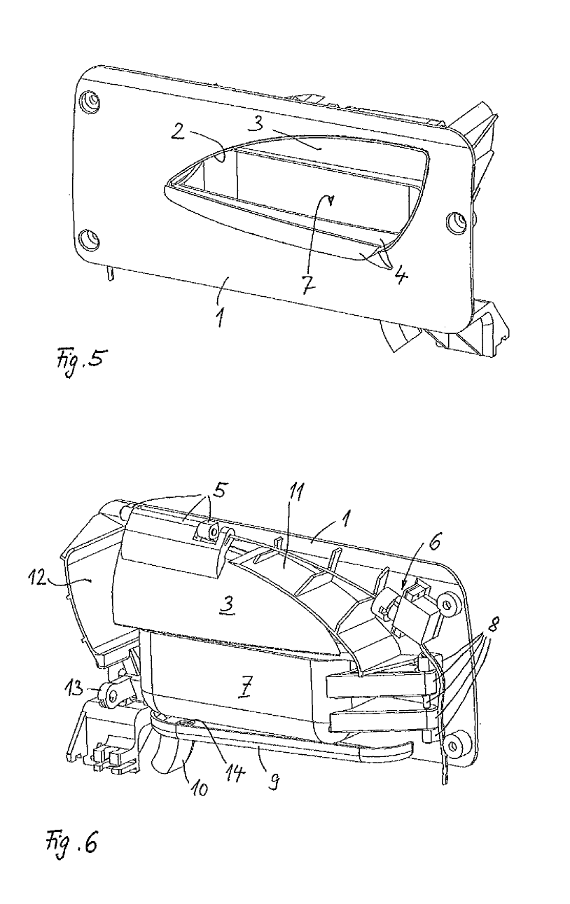

A passenger vehicle has at least one motor vehicle door on both opposite sides of a vehicle. A detail of a left motor vehicle door of the passenger vehicle is shown with reference to FIGS. 1 to 6. For reasons of clarity, of the motor vehicle side door, only a partial region of a door outer skin 1 which has a door recess 2 is illustrated. The door recess 2 forms a cutout in the door outer skin 1. The door recess 2 is part of a door handle arrangement which is assigned to the door outer skin 1 of the motor vehicle door and serves for opening and closing the motor vehicle door. The door handle arrangement comprises a cover 3 which, in the inoperative position thereof, conceals the door recess 2 over a large part of the surface thereof flush with the door outer skin 1 and flush with an edge region of the door recess 2. Below the cover 3, the remaining surface region of the door recess 2 is concealed by a front side of a cover section 4, wherein the front side forms an outwardly facing outer side of the cover section 4. In the inoperative position of the cover section 4, the front side is aligned flush with the cover 3 and with the door outer skin 1. Accordingly, the door recess 2 is closed by the cover 3 and the cover section 4 in a manner flush with the outer skin.

As can be seen with reference to FIGS. 2, 4 and 6, the cover 3 is mounted on the inside of an upper edge region of the door recess 2 so as to be pivotable by means of a pivot mounting 5 about a pivot axis S₁. It can also be seen with reference to FIGS. 2, 4 and 6 that the cover section 4 extends inwards in the transverse direction of the vehicle and is formed in one piece with a recessed grip 7. The recessed grip 7 and the cover section 4 form a movable handle element within the context of the invention. The recessed grip 7 extends downwards from an upper side of the cover section 4 behind the door outer skin 1, i.e. on the inside of the door outer skin 1, as can be seen with reference to FIGS. 2 to 6. The recessed grip 7 forms an upwardly open shell which is formed in one piece with the cover section 4. The cover section 4 extends rearwards from the front side within the alignment of the door recess 2 with the recessed grip 7. The recessed grip 7 is mounted together with the cover section 4 on a front edge region of the door recess 2—as seen in the normal direction of travel of the passenger vehicle—so as to be pivotable by means of a pivot bearing 8 about a pivot axis S₂. The pivot axis S₂ extends substantially in the vertical direction of the vehicle. By contrast, the pivot axis S₁ of the cover 3 extends at least substantially in the longitudinal direction of the vehicle. The pivot mounting 8 comprises support extensions which are in one piece with the recessed grip 7 and are mounted so as to be pivotable about the pivot axis S₂ by means of bearing brackets arranged on the inner side of the door outer skin 1.

The recessed grip 7 has a sidewall which faces the door outer skin 1 and is positioned at a distance from the door outer skin 1 in order to permit a limited pivotability of the recessed grip 7 towards the outer skin 1. By contrast, the cover section 4, which is in one piece with the recessed grip 7, extends outwards from said sidewall of the recessed grip 7 in alignment with the door recess 2 such that the cover section 4 can be pivoted outwards over the door outer skin 1 above the lower edge region of the door recess 2 (see FIG. 5). The pivotability of the cover section 4 and therefore of the entire handle element is limited to the outside by the fact that the sidewall of the recessed grip 7 comes to bear on the inner side of the outer skin 1 below the lower edge region of the door recess 2. In addition, the recessed grip 7 and the cover section 4 are assigned an inner end stop which ensures that the recessed grip 7 and the cover section 4 pivot inwards again from the actuating position according to FIG. 5 only until the front side of the cover section 4 is flush with the door outer skin 1.

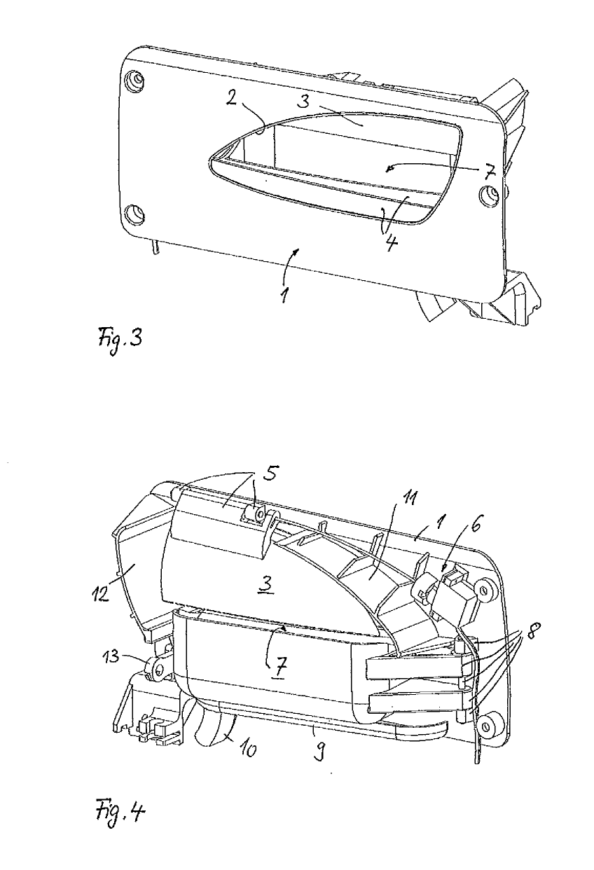

The cover 3 is mounted pivotably between an inoperative position flush with the door outer skin 1 and an actuating position (see FIGS. 3 to 6) which is pivoted inwards into the door recess 2. The pivot mounting 5 is designed in such a manner that an end stop is provided in the region of the inner side of the door outer skin 1 for the inoperative position of the cover 3. A defined securing by means of an end stop or by means of locking a drive unit 6 for the cover 3 is also produced for the actuating position of the cover 3. The cover 3 is transferred by means of a drive unit 6 from the inoperative position into the actuating position which is formed by an electric motor and a mechanical drive transmission device.

A Bowden cable release 13 is fixedly connected to the recessed grip 7 and to the cover section 4, i.e. to the handle element, said Bowden cable release opening a corresponding door lock of the motor vehicle door when the handle element is transferred into the actuating position.

The recessed grip 7 is designed so as to be open at least in sections in the base region thereof (not illustrated) in order to permit water and moisture to pass downwards from the recessed grip 7. A water-catching shell 9 is provided at a small distance below the base region of the recessed grip 7, the water-catching shell 9 being arranged in a manner mounted on the door by being fixedly connected to an inner side of the door outer skin 1. The water-catching shell 9 is provided with a water outlet opening 14 which leads into a water outlet connecting pipe 10. In the operation ready state of the door handle arrangement, the water outlet connecting pipe 10 is connected in a water-conducting manner to a water outlet system of the motor vehicle door in order to permit water to be removed to the lower side of the vehicle, i.e. to a lower side of the motor vehicle door.

On the inner side of the door outer skin 1, covering elements 11, 12 are also provided on the edge region of the door recess 2, said covering elements protruding inwards in the transverse direction of the vehicle approximately at a right angle to the inner side of the door outer skin 1 and being fixedly connected to the inner side of the door outer skin 1. The covering elements 11, 12 serve as protection for corresponding functional parts and functional sections of the door handle arrangement. The covering element 11 protects the mechanical drive transmission device and the electric motor of the drive unit 6 against access from the outside through the door recess. The covering element 12, which is likewise fixedly connected to the inner side of the door outer skin 1, also protects functional parts or functional sections of the door handle arrangement, in particular a door lock (not illustrated) or a Bowden cable arrangement (likewise not illustrated).

The door outer skin 1 of the door handle arrangement, as illustrated with reference to FIGS. 1 to 6, can be formed by a partial region of a door outer panel of the motor vehicle door. Alternatively, the door outer skin can also be designed as a support plate which is connected directly in a flush manner to the door outer panel. In this embodiment of the door outer skin 1 as a support plate, the door handle arrangement illustrated with reference to FIGS. 1 to 6 can be produced as a preassembly unit in order subsequently to be connected fixedly and in a sheetlike manner to the door outer panel of the motor vehicle door by means of the door outer skin 1, which serves as a support plate. In this embodiment, the door outer panel has a cutout coordinated with the door recess 2. In this embodiment, the cover 3 and the front side of the cover section 4, in the inoperative position thereof, can protrude outwards by a small amount, in particular by 1 to 1.5 mm, over the surface of the door outer skin 1 forming the support plate, in order in the region of the cutout in the door outer panel, in the mounted state of the support plate, then to end in an exactly flush manner in alignment with the outer surface of the door outer panel, which is of a thickness of approximately 1 mm to 1.5 mm.

1. Door handle arrangement for a motor vehicle door, with a door recess in which a movably mounted handle element for actuating a door lock is arranged recessed relative to a door outer skin, and with a cover for covering the door recess, the cover being arranged movably between an inoperative position running flush with the door outer skin and an actuating position, wherein the handle element has a movable recessed grip which remains behind the door outer skin—as viewed from the outside—both in an inoperative position and in an actuating position.

2. Door handle arrangement according to claim 1, wherein the handle element comprises a cover section which is shiftable with the recessed grip and, in the inoperative position, covers a part of the door recess below the cover in a manner flush with the outer skin, and which, in the actuating position, protrudes outwards over the door outer skin.

3. Door handle arrangement according to claim 2, wherein the cover section is formed integrally with the recessed grip.

4. Door handle arrangement according claim 1, wherein the recessed grip is designed to be open at least in sections on the base side.

5. Door handle arrangement according to claim 4, wherein a water-catching shell is provided in a manner mounted on the door below the recessed grip, the water-catching shell having a water outlet, which, in an operating state, is connected to a water outlet system.

6. Door handle arrangement according to claim 1, wherein the handle element is mounted with the recessed grip and the cover section on a front or rear edge region of the door recess so as to be pivotable about a pivot axis extending at least substantially in the vertical direction of the vehicle.

7. Door handle arrangement according to claim 1, wherein the cover is mounted on an upper edge region of the door recess so as to be pivotable about a pivot axis extending at least substantially in the longitudinal direction of the vehicle.

8. Door handle arrangement according to claim 1, wherein the cover is assigned a drive unit for transferring the cover into the actuating position and/or into the inoperative position.

9. Door handle arrangement according to claim 8, wherein the drive unit comprises an electric motor which is coupled to a door lock controller in such a manner that the cover is transferred into the actuating position when the door lock is unlocked.

10. Door handle arrangement according to claim 1, wherein, in the actuating position, the cover is pivoted inwards into the door recess.
